(19) United States
(12) Patent Application Publication
(10) Pub. No.: US 2013/0300563 A1
(43) Pub. Date: Nov. 14, 2013

(54) MOBILE INCIDENT REPORTING OF ORGANIZED RETAIL CRIME

(71) Applicant: Raymond Glaze, Lawrenceville, GA (US)

(72) Inventor: Raymond Glaze, Lawrenceville, GA (US)

(21) Appl. No.: 13/890,244

(22) Filed: May 8, 2013

Related U.S. Application Data
(60) Provisional application No. 61/644,849, filed on May 9, 2012.

(51) Int. Cl. G08B 13/22

(52) U.S. Cl. CPC G08B 13/22
USPC 340/568.1

(57) ABSTRACT

Implementations of this disclosure provide systems and methods for users to create and send incident reports using a portable electronic device such as a mobile device. In some implementations, the incident reports are sent to a plurality of registered mobile devices or other electronic devices. In some implementations, the reports are sent real-time or near real-time. In some implementations, the incident reports involve incidents of retail crime including ORC or any other illegal or suspicious activity. In some implementations, the user is a member of a retail organization and the reports are sent to members of a retail organization.

### CROSS REFERENCE TO RELATED APPLICATION

This application claims the benefit of U.S. Patent Application Ser. No. 61/644,849, which was filed on May 9, 2012, and is incorporated herein by reference in its entirety.

### TECHNICAL FIELD

This disclosure relates to mobile incident reporting of organized retail crime.

### BACKGROUND

Organized retail crime (ORC) generally refers to illegally obtaining retail merchandise through theft or fraud over multiple occurrences, in multiple stores, and/or in multiple jurisdictions usually by two or more persons. Oftentimes, ORC groups target several retailers in one day and move from state to state stealing and reselling merchandise. Retailers have tried to solve the problem of ORC by sharing intelligence and working with local, state and federal law enforcement agencies. However, none of the solutions to combat ORC involve real-time or near real-time solutions.

### BRIEF DESCRIPTION OF THE DRAWINGS

FIG. 1 illustrates an example implementation of a Retail Net-Alert system according to the principles of the present disclosure.

FIG. 2-11 illustrates example screen shoots of a Retail Net-Alert App.

### DETAILED DESCRIPTION

Implementations of this disclosure provide systems and methods for users to create and send incident reports using a portable electronic device such as a mobile device. In some implementations, the incident reports are sent to a plurality of registered mobile devices or other electronic devices. In some implementations, the reports are sent real-time or near real-time. In some implementations, the incident reports involve incidents of retail crime including ORC or any other illegal or suspicious activity. In some implementations, the user is a member of a retail organization and the reports are sent to members of a retail organization.

Furthermore, implementations of this disclosure provide systems and methods for a user to opt-in to receive incident reports on the user's mobile device or other electronic device. In some implementations, the user can specify the types of incidents reports (e.g., based on location of the incident, organization, or the type of merchandise at issue) the user wants to receive.

In some implementations, an incident report for an incident may include one or more of the following: author of the incident report, name of the organization affected, date and time of the incident, location of the incident, and a description of the incident, suspect(s), vehicle, and merchandise involved. In some implementations, the incident report also may include a photograph.

In some implementations, an incident report may be sent via text message, voice message, email, or any combination of the foregoing. In some implementations, an incident report may be sent to others based on the organization, location, or any other preference.

In an alternative implementation, systems and methods of the present disclosure can be used for real-time or near real-time reporting of residential crimes to a group of people.

By providing timely advanced notification to others, future or impending criminal activity may be prevented.

To facilitate users creating, sending, and receiving incident reports using a portable electronic device, a mobile application (hereinafter “Retail Net-Alert App”) is downloaded onto the portable electronic devices of the users. A mobile operation system specific Retail Net-Alert App may be provided for different mobile operating systems such as, but not limited to, Android from Google Inc., iOS from Apple Inc., a BlackBerry mobile OS from BlackBerry, and Windows Phone from Microsoft.

The Retail Net-Alert App interfaces with a Retail Net-Alert web server to send and receive incident reports. Through the Retail Net-Alert App, a constant connection can be maintained between the Retail Net-Alert server and the portable electronic device to receive incident reports based on the settings of the user.

In some implementations, the Retail Net-Alert App on the portable electronic device in conjunction with the Retail Net-Alert server can maintain and display a log of past incident reports.

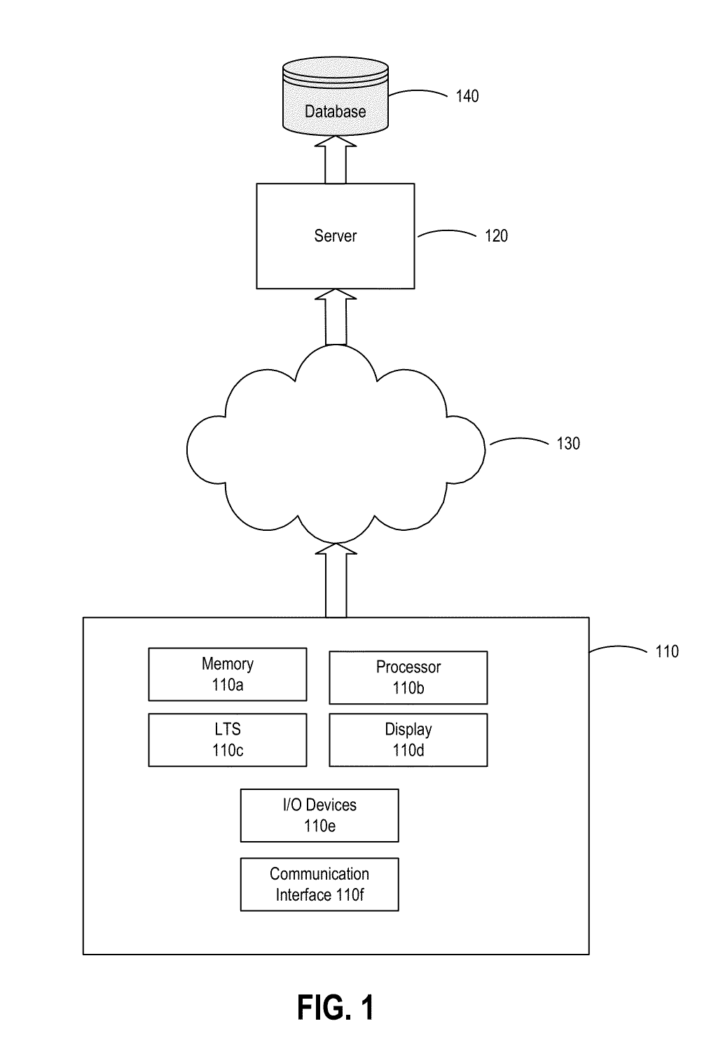

FIG. 1 illustrates an example Retail Net-Alert system 100 according to implementations of the present disclosure. The example Retail Net-Alert system 100 includes a plurality of portable electronic devices such as portable electronic device 110, a Retail Net-Alert server 120, and a network 130.

When a portable electronic device (e.g., portable electronic device 110) downloads the Retail Net-Alert App (e.g., from an app store), the Retail Net-Alert App interfaces with the Retail Net-Alert server 120 via a network (e.g., network 130) to send and receive incident reports. In some implementations, incident reports are sent to the portable electronic device 140 based on the setting of the user, which can be stored in a database 140. The Retail Net-Alert App and/or any related, required, or useful applications, plug-ins, readers, viewers, updates, patches, or other code for executing the Retail Net-Alert App may be downloaded via a network or installed on the portable electronic device 110 in any other known manner.

Network 130 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data) via any one or more wired and/or wireless communication links. The network(s) may include any communication link known to persons of skill, including for example, cloud, cellular or satellite transmission, magnetic or optical media, radio frequency transmission, microwave or fiber optic transmission, or communications via Internet, cable, or satellite providers.

A portable electronic device 110 may be any type of portable or mobile electronics device, such as for example, a smartphone, a cell phone, a mobile telephone, personal digital assistant (PDA), laptop computer, tablet-style computer, or any other device that a user may hold in his or her hand. For example, in some embodiments, the portable electronic device 110 may be a smart phone, such as an iPhone by Apple Inc., a Blackberry phone by RIM, or a phone using an Android operating system (OS), for example.

As illustrated in FIG. 1, portable electronic device 110 may include a memory 110a, processor 110b, location tracking system 110c, a display 110d, input/output devices 110e, and a communication interface 110f.

The memory 110a may store the Retail Net-Alert App and other data (e.g., location data, configuration settings of the device, and any other data required for the Retail Net-Alert App to run, etc.). The memory 110a may comprise any one or more devices suitable for storing electronic data, e.g., RAM, DRAM, ROM, internal flash memory, external flash memory cards (e.g., Multi Media Card (MMC), Reduced-Size MMC (RS-MMC), Secure Digital (SD), MiniSD, MicroSD, Compact Flash, Ultra Compact Flash, Sony Memory Stick, etc.), SIM memory, a rewritable optical disk, a rewritable magnetic tape, and/ or any other type of volatile or non-volatile memory or storage device. The Retail Net-Alert App may be embodied in any combination of software, firmware, and/or any other type of computer-readable instructions.

The processor 110b may include a microprocessor, a microcontroller, a digital signal processor (DSP), an application specific integrated controller (ASIC), electrically-programmable read-only memory (EPROM), or a field-programmable gate array (FPGA), or any other suitable processor(s), and may be generally operable to execute instructions for the Retail Net-Alert App, as well as providing any other functions of the portable electronic device 110. The processor 110b can be a number of processors, a multi-processor core, or some other type of processor, depending on the particular implementation. The processor 110b can be implemented using a number of heterogeneous processor systems in which a main processor is present with secondary processors on a single chip.

The portable electronic device 110 may include a location tracking system 110c for determining the geographic location of the portable electronic device 110. For example, the location tracking system 110c can include a global positioning system (“GPS”) receiver for accessing a GPS application function call that returns the geographic coordinates (i.e., the geographic location) of the portable electronic device 110. As another example, the positioning system can utilize any suitable trilateration or triangulation technique to determine the geographic coordinates of the portable electronic device 110. In some embodiments, the location tracking system 110c can determine various measurements (e.g., signal-to-noise ratio (“SNR”) or signal strength measurements) of a network signal (e.g., a cellular telephone network signal, a wireless network access point or “hot spot,” or any other suitable network signal) associated with the portable electronic device 110 to determine its location.

The display 110d may comprise an LCD screen (e.g., thin film transistor (TFT) LCD or super twisted nematic (STN) LCD), an organic light-emitting diode (OLED) display, or any other suitable type of display. In some embodiments, the display 110d may be an interactive display (e.g., a touch screen).

The input/output devices 110e may include any suitable interfaces allowing a user to interact with the portable electronic device 110. For example, input/output devices 110e may include a touch screen, physical buttons, sliders, switches, data ports, keyboard, mouse, voice activated interfaces, or any other suitable devices.

The communication interface 110f can be any interface that enables communication between the portable electronic device 110 and external devices, machines and/ or elements such as web server 130 or an app store. Communication interface 110f may include, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, or any other such interfaces for connecting the portable electronic device 110 to other computing devices and/or communication networks such as the Internet. Such connections can include a wired connection or a wireless connection (e.g. 802.11) though it should be understood that communication interface 140f can be practically any interface that enables communication to/from the portable electronic device 110.

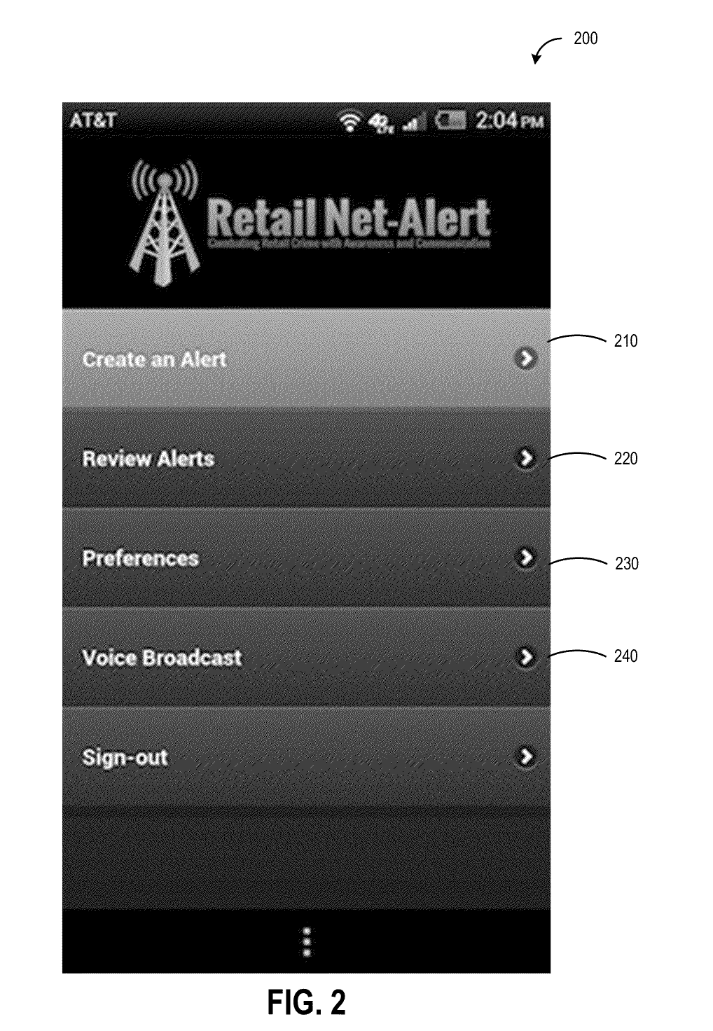

Once the Retail Net-Alert App is downloaded to the portable electronic device and launched, FIGS. 2-11 illustrate example screen shoots 200 of the Retail Net-Alert App. As illustrated in FIG. 2, a user may select a menu item to create and send an incident report 210, to review past incident reports 220, to set preferences regarding the receipt of incident reports 230, or to send a voice message 240.

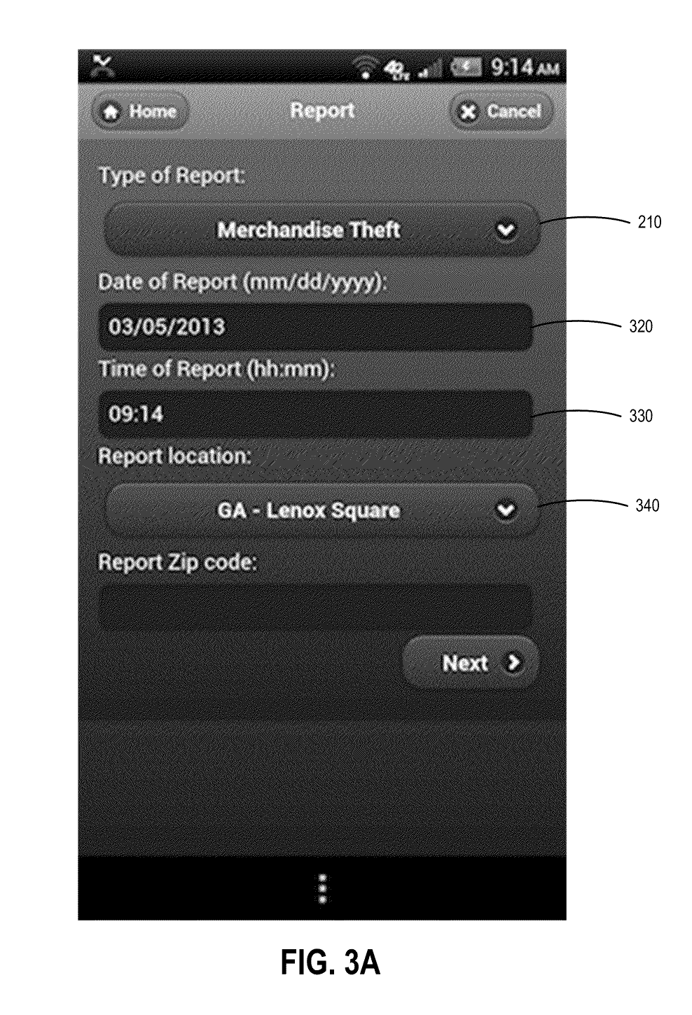

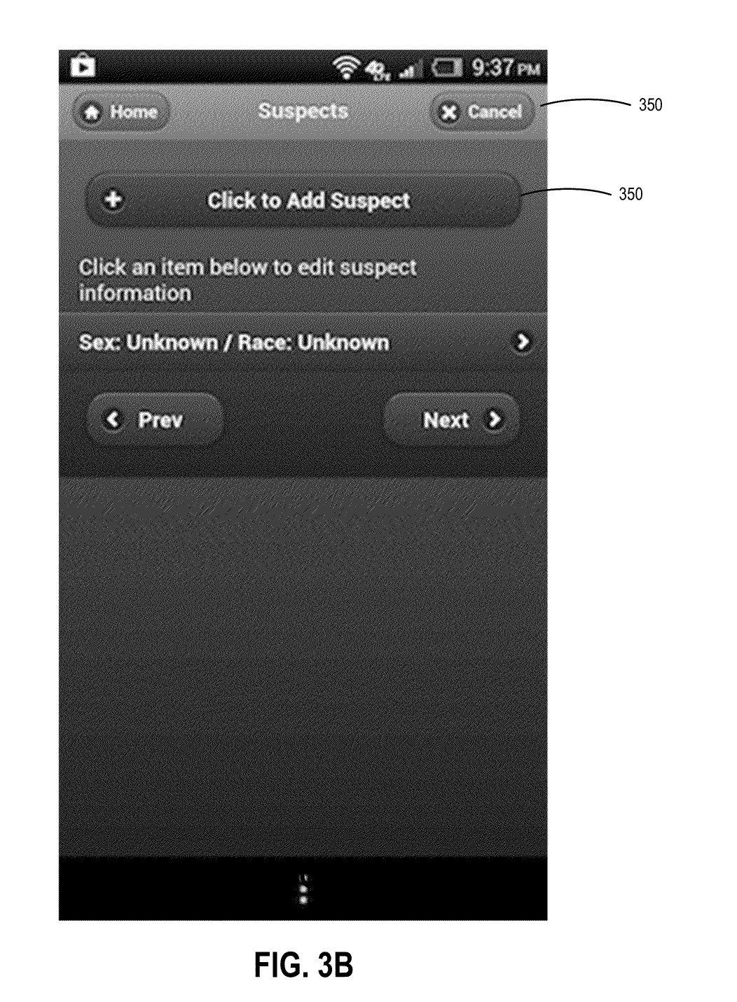

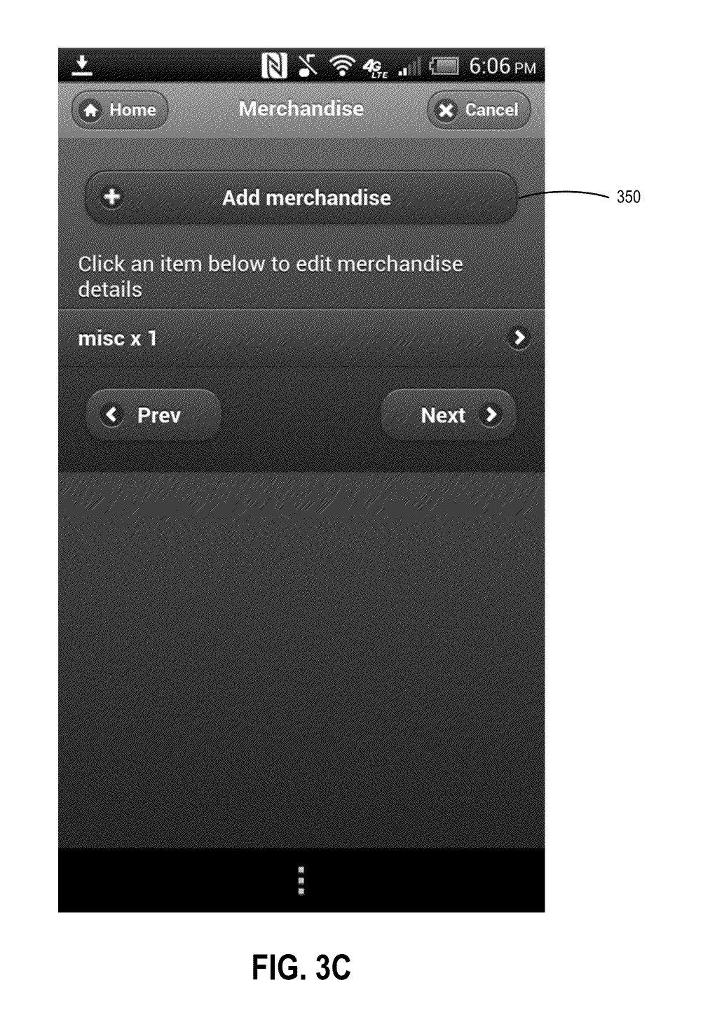

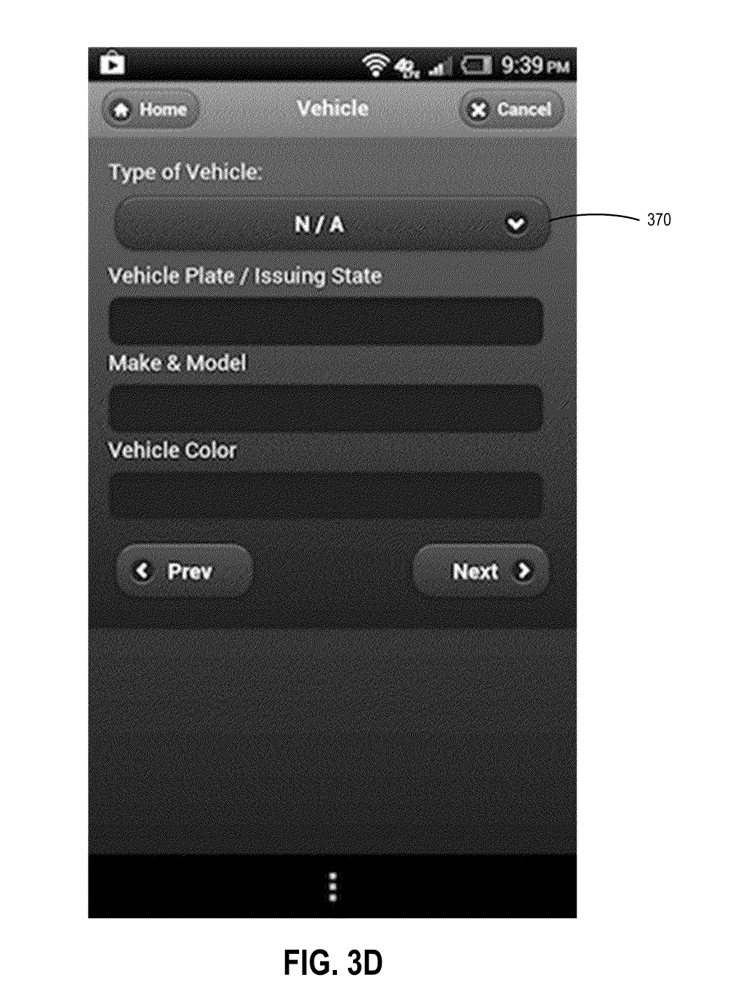

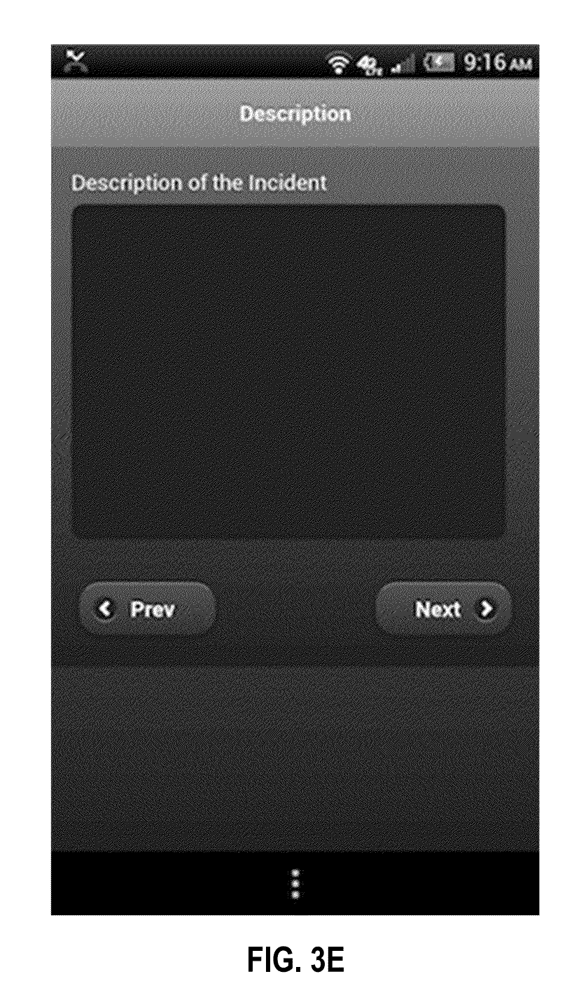

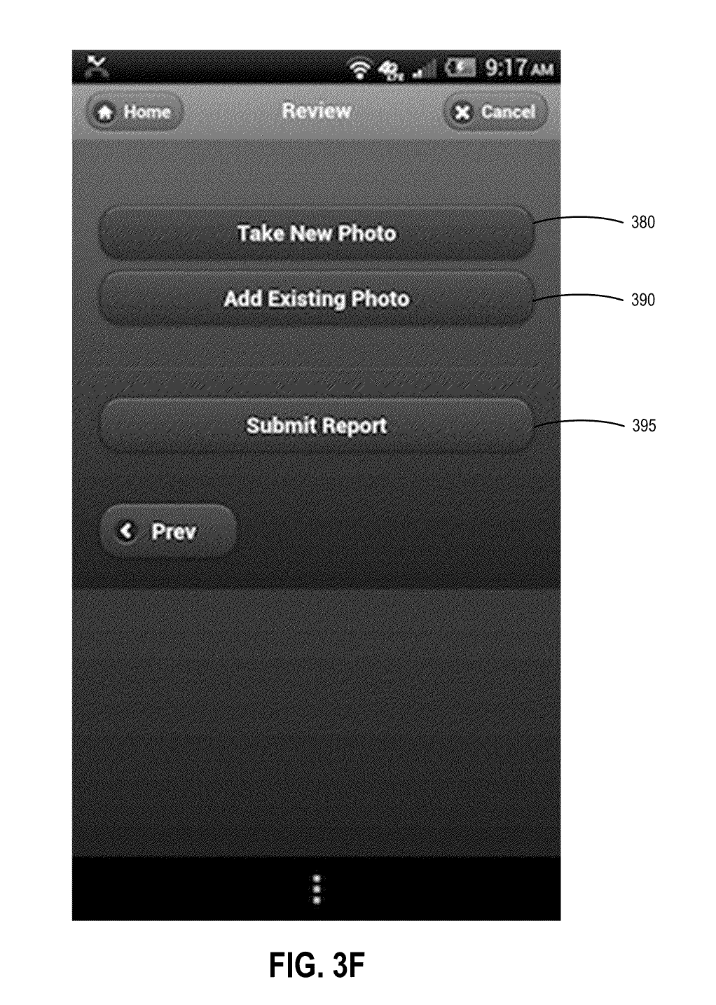

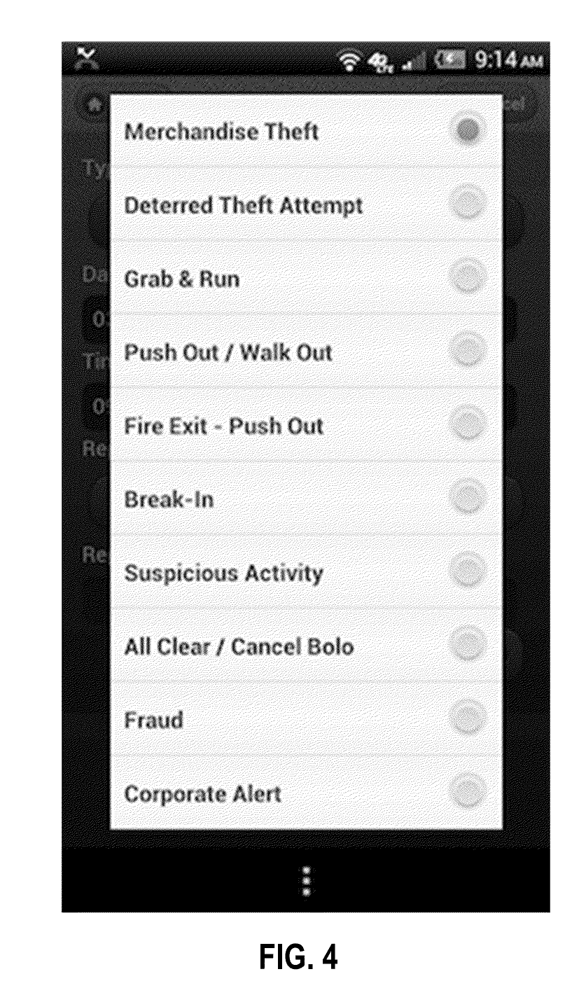

If the user chooses to create an incident report (e.g., by pressing the “Create An Alert” button 210), FIGS. 3A-3F illustrates sample screens the user may encounter while creating the incident report. For example, after selecting the menu item to create and send an incident report 210, the user can specify the type of incident report or alert to send. In some implementations, the user can type-in the type of incident report or alert. In some implementations, the user can specify the type of incident report or alert from a drop down menu 310. In some implementations, as illustrated in FIG. 4, the types of incident reports or alerts available from a drop-down menu may include merchandise theft, deterred theft attempt, grab and run, push out/walk out, fire exit-push out, break-in, suspicious activity, all clear/cancel alert, fraud (e.g., credit card, stolen check, gift cad, counterfeit cash, fraudulent send, fraudulent return, etc.), and corporate alert (e.g., weather alert, promotional or price alert, store hour changes, etc.). Any other type of incident or alert may be included in the drop down menu.

Returning to FIG. 3A, the user also can specify the date of the incident 320. In some implementations, the user may type in the date. In some implementations, the user may select a date from a calendar. The user also can specify the time of the incident 330 either by typing in the information or selecting the information from a drop-down menu. In some implementations, the time field may be auto-filled with the current time. The user also can specify the location including the zip code of the incident 340. In some implementations, the user can type-in the location of the incident or alert. In some implementations, the user can specify the location (e.g., points of interests in a geographical region) of the incident from a drop-down menu. In some implementations, the location field may be auto-filled with the location pre-stored for the user.

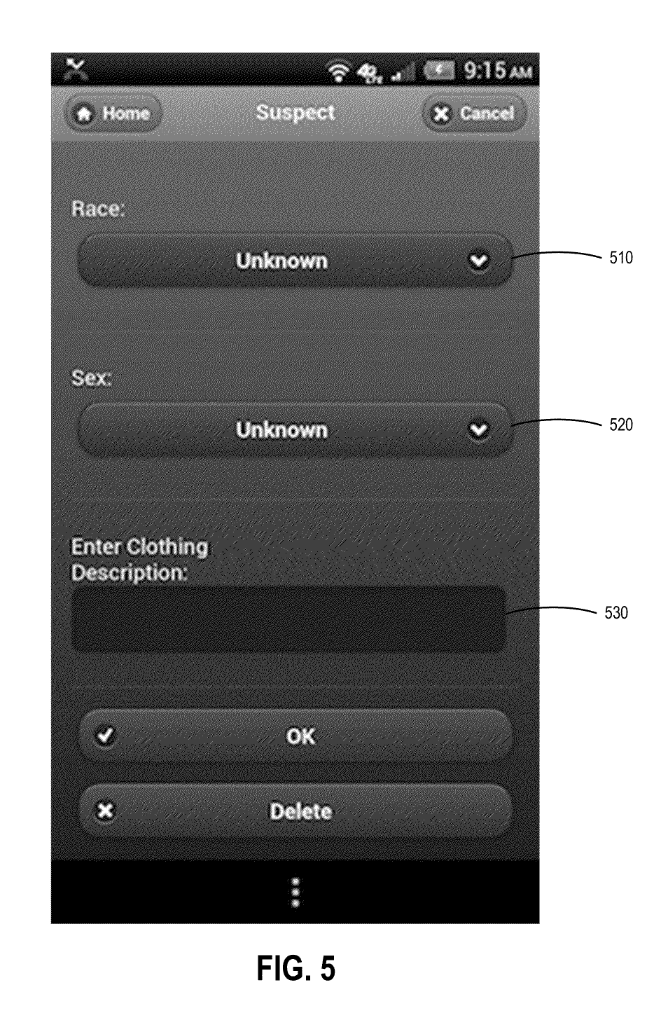

As shown in FIG. 3B, the user also can add information about the suspect of the incident by selecting the appropriate button 350. After selecting to add information about the suspect, in some implementations, the user can specify the suspect's race and sex as shown in FIG. 5. In some implementations, the user can type-in the race and/or sex of the suspect. In some implementations, the user can specify the race and/or sex of the suspect from drop-down menus 510, 520. The user also can specify a clothing description of the suspect. In some implementations, the user can type in 530 the clothing description.

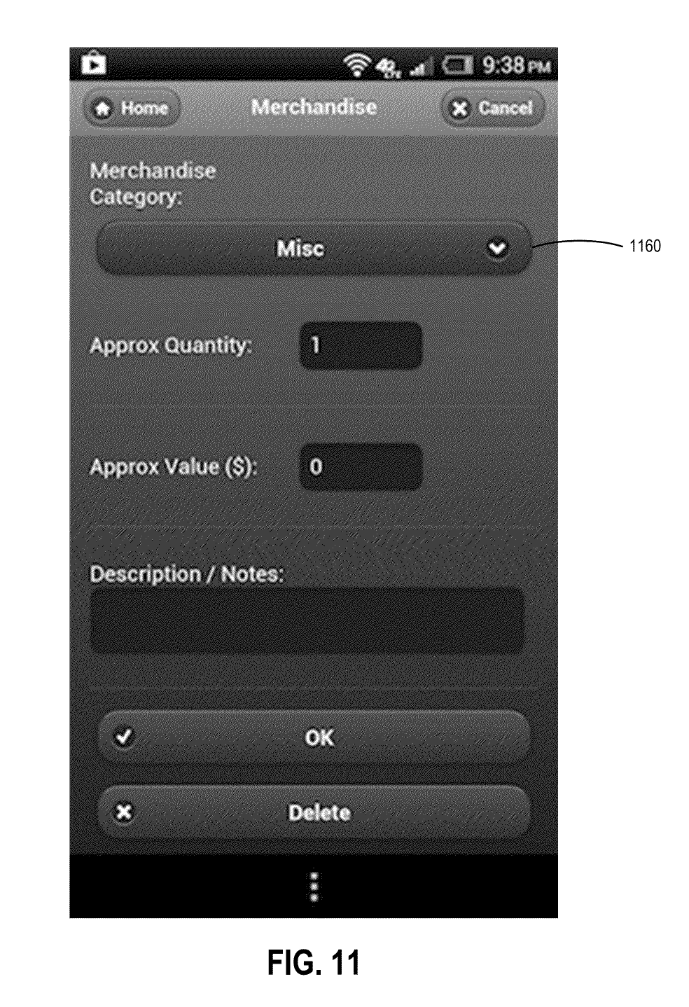

As shown in FIG. 3C, the user also can specify the type of merchandise involved in the incident by selecting the appropriate button 360. After selecting to add information about the merchandise involved, in some implementations, the user can type-in the type of merchandise involved in the incident. In some implementations, the user can specify the type of merchandise involved in the incident from a drop-down menu 1160 as shown in FIG. 11. The drop-down menu for merchandise type may include one or more of the following items: miscellaneous, denim jeans, designer clothing, handbags, high-end vacuums, kitchen aid mixers, accessories, beauty/fragrances, bed/bath, home, or any other type of merchandise type. In some implementations, the user can type-in the type of merchandise involved in the incident. In some implementations, the user can specify the type of merchandise involved in the incident from a drop-down menu 370. In some implementations, the user can specify the quantity of merchandise involved in units and/or value.

As shown in FIG. 3D, the user also can specify the type of vehicle involved in the incident. In some implementations, the user can type-in the type of vehicle involved in the incident. In some implementations, the user can specify the type of vehicle involved in the incident from a drop-down menu 370. In some implementations, the user can specify the license plate information including the issuing state. In some implementations, the user also can specify the make and model of the vehicle either by typing in the information or selecting the information from a drop-down menu. In some implementations, the user can specify the color of the vehicle either by typing in the information or select the information from a drop-down menu.

As shown in FIG. 3E, the user also can provide a narrative of the incident. As shown in FIG. 3F, the user also include a picture by selecting the appropriate button to either take a new picture 380 or uploading an existing picture 390.

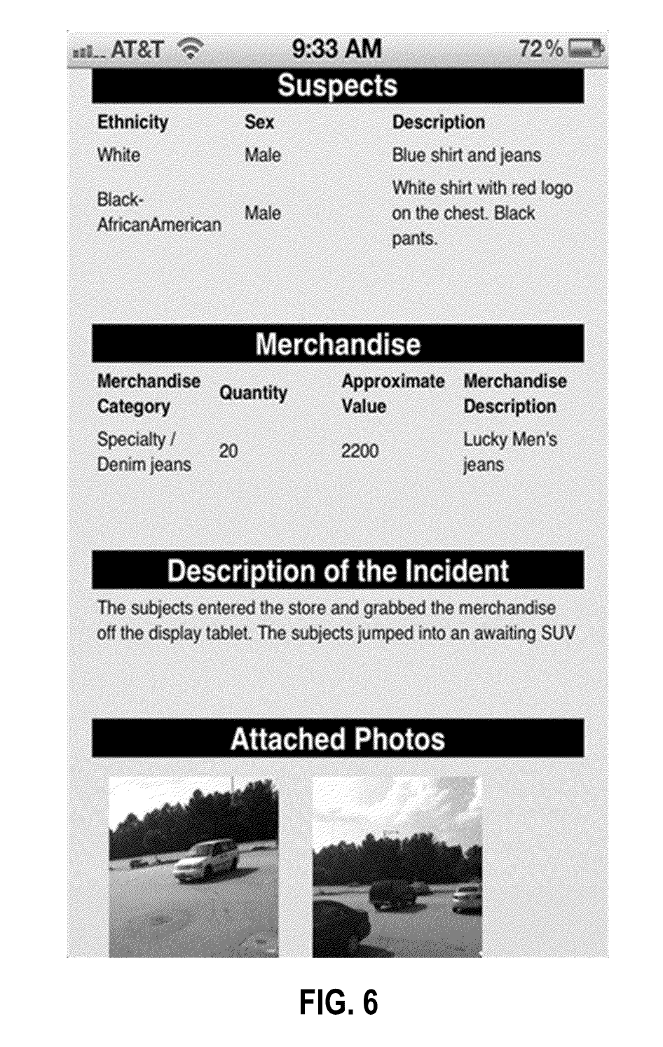

After entering the information for the incident, the user can submit the incident report (e.g., by pressing a “Submit Report” button 395) to the Retail Net-Alert server 120 for distribution to others based on pre-stored settings in database 140. FIG. 6 illustrates an example incident report created based on a user's input.

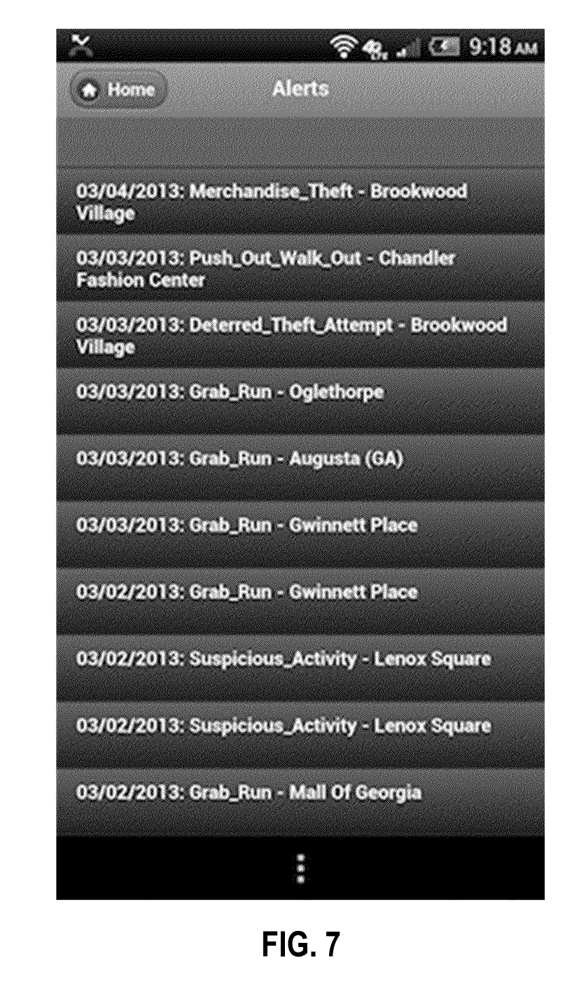

Returning to FIG. 2, the user also can review past incident reports (e.g., by pressing the “Review Alerts” button 220). After selecting to review past incident reports, in some implementations, the Retail Net-Alert App may display a listing of past incident reports as shown in FIG. 7, for example. In some implementations, the listing may include the date, incident type, and location of past incident reports. In some implementations, the user can select a listing and further details regarding the incident will be displayed (e.g., as shown in FIG. 6).

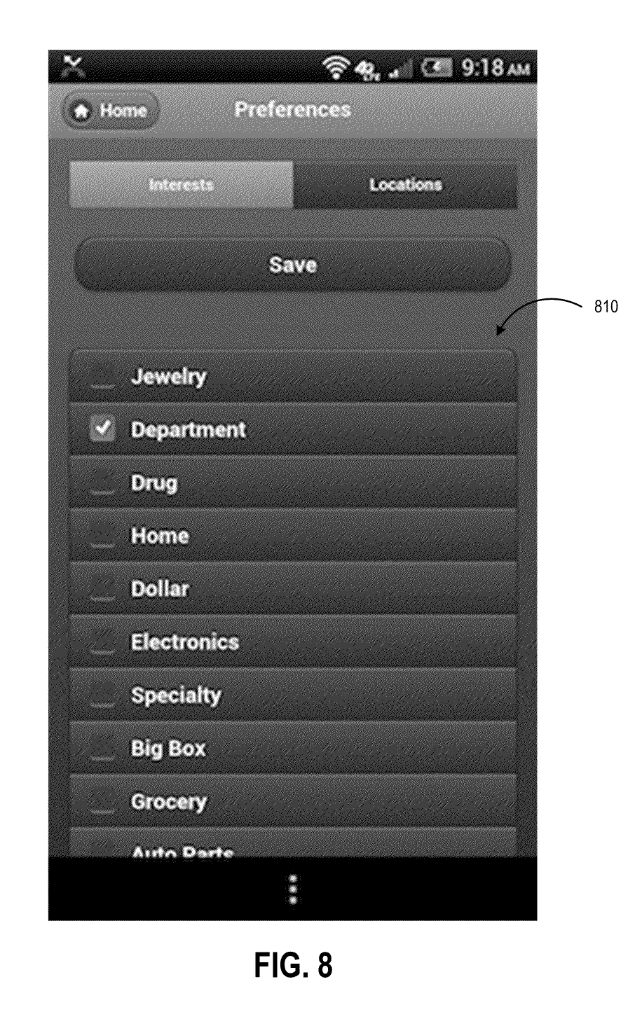

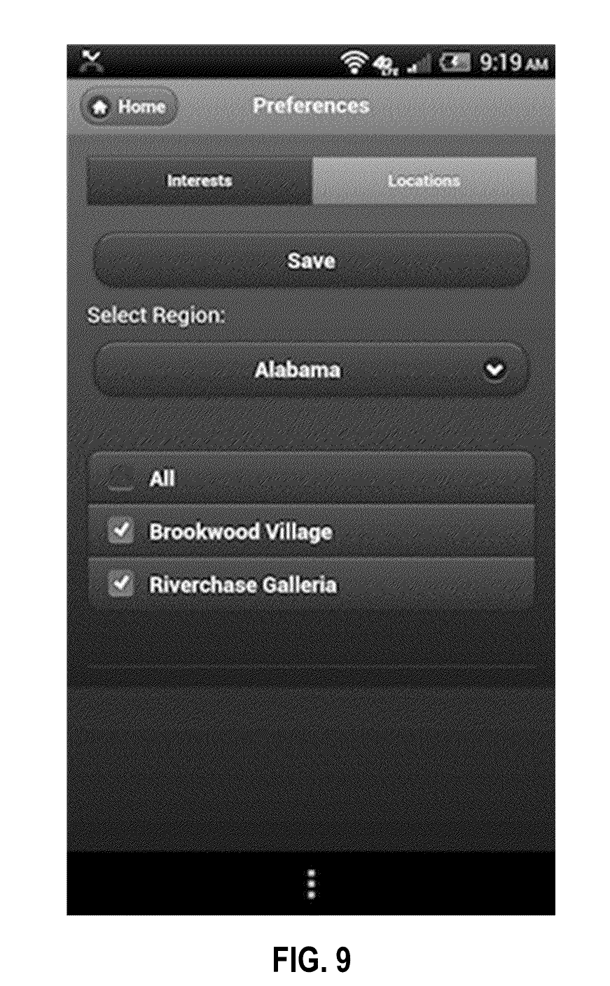

As shown in FIG. 2, the user also can specify the types of incidents reports (e.g., based on location of the incident, organization, or the type of merchandise at issue) the user wants to receive (e.g., by pressing the “Preferences” button 230). In some implementations, the user can specify the types of incident reports that the user wants to receive based on categories and or location. The user can specify the categories of incident reports either by typing in the category or selecting the categories from a menu such as the example menu 810 illustrated in FIG. 8. In some implementations, the drop-down menu 810 may include items in the merchandise drop down menu 360 discussed above. Similarly, as shown in FIG. 9, the user can specify the location of incident reports the user wants to receive. The user can specify the location either by typing in the locations or selecting the location from a drop-down menu. The location can be specified based on city and state, state, region, address, or any other way. In some implementation, the user can specify locations of interest by selecting geographical areas on a map.

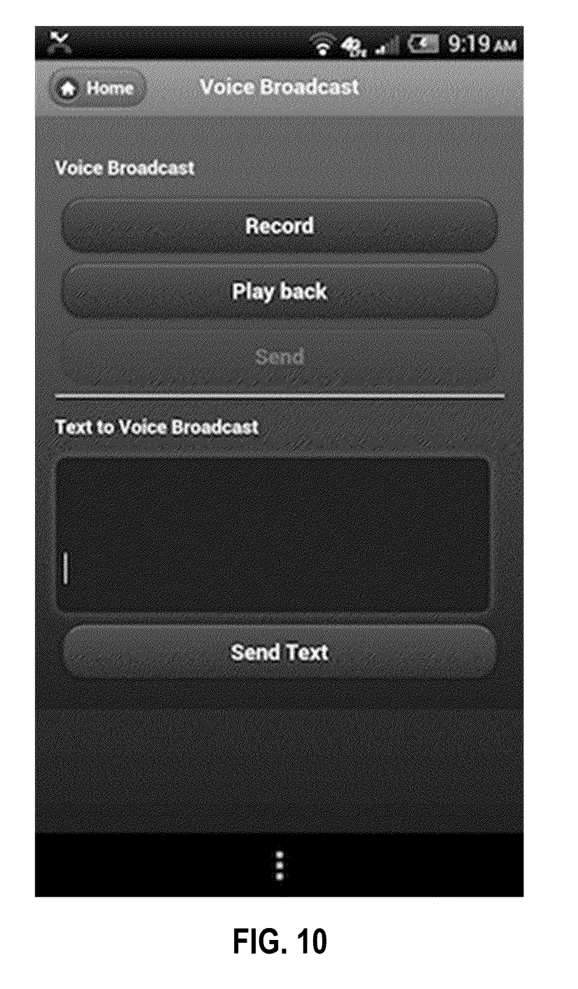

Returning to FIG. 2, the user also can send a voice message (e.g., by pressing the “Voice Broadcast” button 240). After selecting to send a voice message, FIG. 10 illustrates a sample screen the user may encounter while creating a voice message. As shown in FIG. 10, the user may record a voice message or enter text, which can be converted to voice. In some implementations, the user can playback the recorded or converted voice message. The user can submit the voice message (e.g., by pressing a “Send” button 710) to the Retail Net-Alert server 120 for distribution to others based on pre-stored settings in database 140.

In some implementations, one or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

In some implementations, the processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Some embodiments may be implemented, for example, using a machine or tangible computer-readable medium or article which may store an instruction or a set of instructions that, if executed by a machine, may cause the machine to perform a method and/or operations in accordance with the embodiments.

Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. To the extent not included above, computer readable media suitable for storing computer program instructions and data also includes all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language. To the extent not included above, such instructions also can comprise, for example, interpreted instructions, such as script instructions, e.g., JavaScript or ECMAScript instructions, or executable code, Standard interchange language (SIL), Component Object Model (COM) enabled programming languages, or other instructions stored in a computer readable medium including existing and future developed instructions specific to portable electronic devices, mobile applications, and servers.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/ or memories into other data similarly represented as physical quantities within the computing system's memories, registers or other such information storage, transmission or display devices. The embodiments are not limited in this context.

To provide for interaction with a user, implementations of the subject matter described in this specification can be operable to interface with a computing device that is integrated with or connected to (directly or indirectly) a display, e.g., a CRT (cathode ray tube) or LCD (liquid crystal display) monitor, for displaying information to the user. To provide for input by a user to the computer, implementations of the subject matter described in this specification further can be operable to interface with a keyboard, a pointing device (e.g., a mouse or a trackball), scanner, a barcode reader, magnetic strip reader, or any other input device.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail. Furthermore, while this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described program components and systems can generally be integrated together in a single software product or packaged into multiple software products.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications and other embodiments will become apparent to the skilled practitioner upon a study of this disclosure.

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

1. A computer-implemented method for distributing incident reports using a portable electronic device, the method comprising:
storing recipient information to forward an incident report;
receiving an incoming incident report created on a portable electronic device; and
transmitting the incoming incident report to one or more recipients based on the stored recipient information.

2. The method of claim 1 wherein the recipient information includes information sufficient to forward the incident report to the recipient as a text message.

3. The method of claim 1 wherein the recipient information includes a description of the type of incident reports the recipient desires to receive.

4. The method of claim 3 wherein the description includes geographical information.

5. The method of claim 3 wherein the description includes organization information.

6. The method of claim 3 wherein the description includes merchandise information.

7. The method of claim 1 wherein the incident report includes the type of incident, the date and time of the incident; the location of the incident, and information regarding one or more suspects involved in the incident.

8. The method of claim 1 wherein the incident report is transmitted such that the incident report is received as a text message on a portable electronic device.

9. The method of claim 1 wherein the incident report is transmitted such that the incident report is received as an email message.

10. The method of claim 1 wherein the incident report is received and transmitted as a voice message.

11. A computer-implemented method for creating incident reports using a portable electronic device, the method comprising:
using a mobile application on a portable device to input incident information regarding an incident; and
transmitting the incident information from the portable electronic device over a network.

12. The method of claim 11 wherein the incident information comprises:
the type of incident;
the date and time of the incident;
the location of the incident, and
information regarding one or more suspects involved in the incident;

13. The method of claim 11 wherein the incident information further comprises a photograph relevant to the incident.

14. The method of claim 11 wherein the incident information further comprises merchandise involved in the incident:

15. The method of claim 11 wherein the incident comprises an incident of retail crime.

16. The method of claim 11 wherein the incident comprises an incident of residential crime.

17. The method of claim 11 further comprising:
receiving the transmitted incident information created on the portable electronic device; and
transmitting the incident information to one or more recipients based on the stored recipient information.

18. A non-transitory computer readable medium containing instructions that, when executed by a processor on a portable electronic device, cause the portable device to:
display a user interface for inputting incident information regarding an incident; and
transmit the incident information from the portable electronic device over a network.

19. The non-transitory computer readable medium of claim 18 wherein the user interface includes one or more display screens for:
inputting the type of incident;
inputting the date and time of the incident;
inputting the location of the incident, and
inputting information regarding one or more suspects involved in the incident.
